(19) United States
(12) Patent Application Publication
(10) Pub. No.: US 2026/0162244 A1
(43) Pub. Date: Jun. 11, 2026

(54) METHOD FOR AUTOMATICALLY DETERMINING THE DEPTH OF A DEFECT DETECTED IN THE SURFACE OF AN OBJECT, AND SYSTEM CONFIGURED TO EXECUTE THE METHOD

(71) Applicant: AIRBUS OPERATIONS SAS, Toulouse (FR)

(72) Inventors: Henri MARTICOU, Toulouse (FR); Raphaël VIARDS, Toulouse (FR)

(73) Assignee: AIRBUS OPERATIONS SAS, Toulouse (FR)

(21) Appl. No.: 19/361,994

(22) Filed: Oct. 17, 2025

(30) Foreign Application Priority Data
Oct. 25, 2024 (FR) 2411667

(51) Int. Cl. G06T 7/00; G06T 7/55; G06T 7/73

(52) U.S. Cl. CPC G06T 7/0008; G06T 7/55; G06T 7/75; G06T 2207/20084; G06T 2207/30252

(57) ABSTRACT

A method for automatically inspecting a surface of a solid object such as, for example, a surface of an aircraft; the method employs a step of detecting a defect in said surface represented in the form of an image that is also a depth map, analyses of successive depth profiles aiming to determine a depth for each of said depth profiles, then determines a “final” depth of a defect based on all the depths of said profiles. The invention further relates to a system configured to execute the method. Advantageously, it is thus possible to automatically determine the depth of non-planarities in a surface of an aircraft with a level of accuracy not previously reached.

### TECHNICAL FIELD

The present invention relates to an improved method for automatically determining the depth of a defect in the surface of an object, which surface is, for example, a surface of an aircraft component, the defect being detected based on pieces of information previously obtained from a surface inspection device, to which pieces of information a detection method is applied. The invention further relates to a system configured to execute such a method.

### PRIOR ART

The automatic inspection and quality-control methods used in industry often save a substantial amount of time in product manufacturing steps. This is particularly advantageous in the case of equipment the manufacture of which requires a high number of components and manufacturing steps, as in such cases an increase in throughput is often sought. Inspection of aircraft surfaces during aircraft manufacturing or maintenance operations is common and there is a need for automatic means for inspecting and detecting potential surface defects allowing a level of perception and detection that is at least as good as that of the human eye, or even better, to be obtained, with a view to detecting surface defects of very small dimensions during manufacturing or maintenance operations.

Although available detection tools and methods allow defects in the surface of objects to be reliably detected, measured values of the depth of a surface defect often vary substantially depending on the tool or method used. Furthermore, when a surface defect is detected beside a component, such as a rivet for example, arranged on the surface in the vicinity of the defect, the modification of the surface caused by the presence of the component makes it more complex to determine the depth of the defect.

The situation could be improved.

### SUMMARY OF THE INVENTION

One objective of the present invention is to increase the accuracy of measurement of the depth of a surface defect detected using means for automatically inspecting surfaces of objects, aircraft surfaces for example, with detecting means capable of detecting a surface defect.

To this end, one subject of the invention is a method for determining a depth of a defect in a surface of an object, said surface being digitally instantiated in the form of a map of distances between a measured real surface of said object and a sensor of a surface inspection system configured to obtain said digitally instantiated surface through an operation of scanning said real surface, said method comprising detection of said defect in said surface, through demarcation of a segment called the “defect region” of said digitally instantiated surface, said method being characterized in that it further comprises:
(i) determining a centre of said defect,
(ii) determining a plurality of depth profiles of the defect, each of said depth profiles being respectively established after a predetermined rectilinear path passing through said centre has been traced through said defect region of the digitally instantiated surface, each of said depth profiles further being determined with reference to a path different from the path determined for the other profiles among said plurality of profiles,
(iii) determining a maximum depth and a confidence index for each of said determined depth profiles, then
(iv) determining said depth of said surface defect based on said maximum depths determined and said confidence indices determined with reference to each of said depth profiles.

Advantageously and by virtue of the proposed method, it is possible to improve the characterization of a defect in the surface of an object and to take corrective actions, where appropriate. For example, it is possible to optimally organize maintenance operations or adaptations of the methods used to manufacture the object exhibiting a defect depending on the depth of the defect, the latter being able to be determined with an increased level of accuracy.

The method according to the invention may further have the following additional features, implemented alone or in combination:
determining the maximum depth of a depth profile using the method comprises an operation of interpolation in the depth profile in question;
determining the depth of the surface defect based on the maximum depths each determined with reference to one profile comprises a calculation of a weighted median;
the method further comprises a step of notifying the presence of said detected defect in said surface.

Another subject of the invention is a method for manufacturing an aircraft component comprising a method for determining the depth of a defect such as described above, and a step of modifying the surface containing the defect based on at least one piece of information representative of the defect.

Another subject of the invention is a system for determining a depth of a defect in a surface of an object, said surface being digitally instantiated in the form of a map of distances between a measured real surface of said object and a sensor of a surface inspection system configured to obtain said digitally instantiated surface through an operation of scanning said real surface, said system comprising electronic circuitry configured to detect said defect in said surface, through demarcation of a segment called the “defect region” of said digitally instantiated surface, said system further comprising electronic circuitry configured to:
(i) determine a centre of said defect,
(ii) determine a plurality of depth profiles of the defect, each of said depth profiles being respectively established after a predetermined rectilinear path passing through said centre has been traced through said defect region of the digitally instantiated surface, each of said depth profiles further being determined with reference to a path different from the path determined for the other profiles among said plurality of profiles,
(iii) determine a maximum depth and a confidence index for each of said determined depth profiles, then
(iv) determine said depth of said surface defect based on said maximum depths determined and said confidence indices determined with reference to each of said depth profiles.

The system according to the invention may further have the following additional features, implemented alone or in combination:
the system comprises electronic circuitry configured to determine a maximum depth of a predetermined depth profile, this comprising an operation of interpolation in a determined depth profile;
the system comprises electronic circuitry configured to determine the depth of the surface defect based on the maximum depths each determined with reference to one profile, determining the depth of the surface defect comprising calculation of a weighted median;
the system comprises electronic circuitry configured to provide notification of the presence of the detected defect in the inspected and analysed surface.

Another subject of the invention is a computer program product comprising program code instructions for executing steps of a method such as described above when these instructions are executed by a processor of a system for determining a depth of a surface defect of a solid object.

Lastly, another subject of the invention is a storage device comprising a computer program product such as mentioned above.

### BRIEF DESCRIPTION OF THE DRAWINGS

FIG. 1 schematically illustrates a system for automatically inspecting the finish of a surface of a solid object according to one embodiment;

FIG. 2 schematically illustrates an aircraft having surfaces that are able to be inspected using the system shown in FIG. 1;

FIG. 3 is a schematic representation of a set of pieces of information representative of the surface of a solid object and taking the form of an image that is also a map of depths (or distances) used as input data of the automatic inspection system shown in FIG. 1;

FIG. 4 is a flowchart illustrating steps of a method for automatically determining the depth of a defect in the surface of a solid object, executed in the automatic inspection system shown in FIG. 1, according to one embodiment;

FIG. 5 illustrates details of an overall step of determining the depth of a defect described with reference to FIG. 4;

FIG. 6 is a diagram illustrating one example of the architecture of a data-processing unit comprising electronic circuitry configured to execute the method described with reference to FIG. 4, according to one embodiment;

FIG. 7 schematically illustrates a defect in a defect detection region of a digitally instantiated inspected surface, according to one embodiment;

FIG. 8 illustrates a depth profile of a defect along a determined path and according to one embodiment;

FIG. 9 illustrates a generalization of a depth profile as shown in FIG. 8; and,

FIG. 10 illustrates one particular case of a depth profile of a defect, according to one embodiment, of such a nature as to cause specific processing of this profile.

### DETAILED DESCRIPTION OF EMBODIMENTS

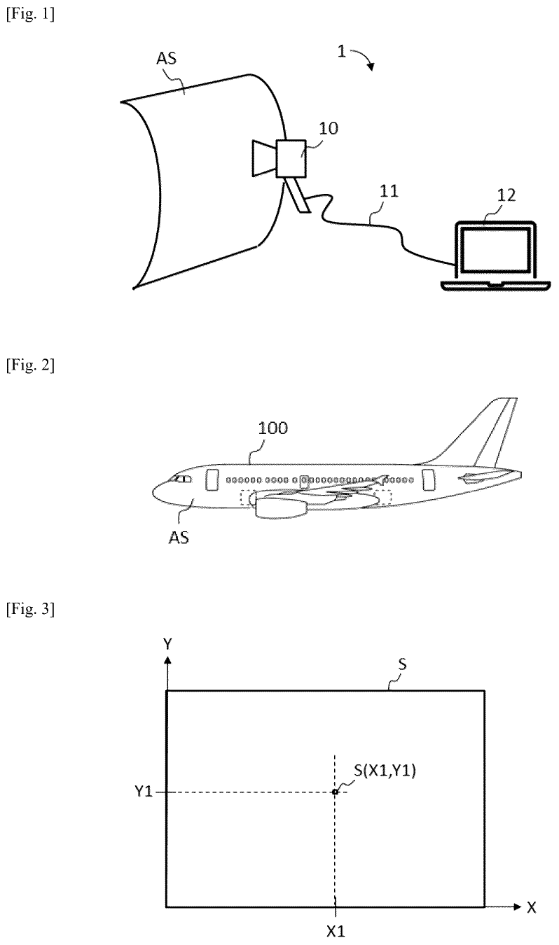

FIG. 1 shows a system 1 for automatically inspecting the finish of a surface AS of a solid object according to one embodiment. The automatic inspection system 1 comprises a sensing device 10 connected to a processing unit 12 via a communication link 11. According to one embodiment, the communication link 11 is wired. According to one variant of embodiment, the communication link 11 is configured to allow wireless communication. According to one embodiment, the sensing device 10 is a camera or a scanner operating as a distance sensor configured to deliver a dataset of the “3D point cloud” type, these data then being representative of the inspected surface AS, or more precisely the surface finish of the inspected surface AS. The distance-sensing device 10 takes measurements of distances between a reference point that it includes and a plurality of points on a surface of a solid object. According to one embodiment, each of the points of the 3D point cloud is instantiated in the form of a pair of x and y coordinates that are considered in combination with a value S (x, y) of a distance with respect to the camera positioned with reference to the normal to the plane tangent to the inspected surface AS in the measurement field of the sensor 10 (camera or scanner, for example). For each inspected region of the surface AS, a 3D cloud of points S (x, y) may be transmitted by the sensing device 10 to the processing unit 12 via the communication link 11. This 3D cloud of points S (x, y) consists of first pieces of information representative of the shape of the inspected surface AS (also referred to here as the “surface finish”) of the inspected surface AS. In other words, this 3D cloud of points S (x, y) is a depth (or distance) map defining a set of distances for the points on the surface AS that are observed and inspected in the measurement field of the sensing device 10. The processing unit 12 is configured to carry out successive processing operations based on these first pieces of information, for the purposes of characterizing surface defects present in the inspected surface AS, such as recesses and reliefs of various shapes and dimensions (impacts, scratches, bumps, hollows, etc.).

FIG. 2 illustrates one example of an inspected surface AS of an aircraft 100. In the example described with reference to FIG. 2, the surface AS is a surface of a component of the fuselage of the aircraft 100. Of course, this example is non-limiting and the automatic inspection system 1 may be useful for inspecting many surfaces of an aircraft, in particular including its fuselage and wings.

FIG. 3 schematically illustrates a data structure comprising the first pieces of information mentioned above, stored in the form of a matrix S of values each of the elements S (X, Y) of which is determined and stored with reference to coordinates X and Y of a plane. For example, an element S (X1, Y1) is representative of the distance between the sensing device 10 and a point on the surface AS the position of which in space is defined by the coordinates X1 and Y1. According to one embodiment, the matrix S of values further forms an image of the respective distances measured for the various points of the matrix S. For example, the brighter a point of the image, the greater the distance between the corresponding point of the inspected surface AS and the distance-measuring sensor of the sensing device 10, or vice versa. The expression “corresponding point of the inspected surface” here designates a point on the inspected surface AS of which a given point of the image (or matrix) S is representative. Thus, the structuring of the obtained first pieces of information is a 3D to 2D conversion of the inspected surface AS into an image S that is able to undergo processing by means of the processing unit 12 for the purposes of detecting the presence of potential defects in the inspected surface AS.

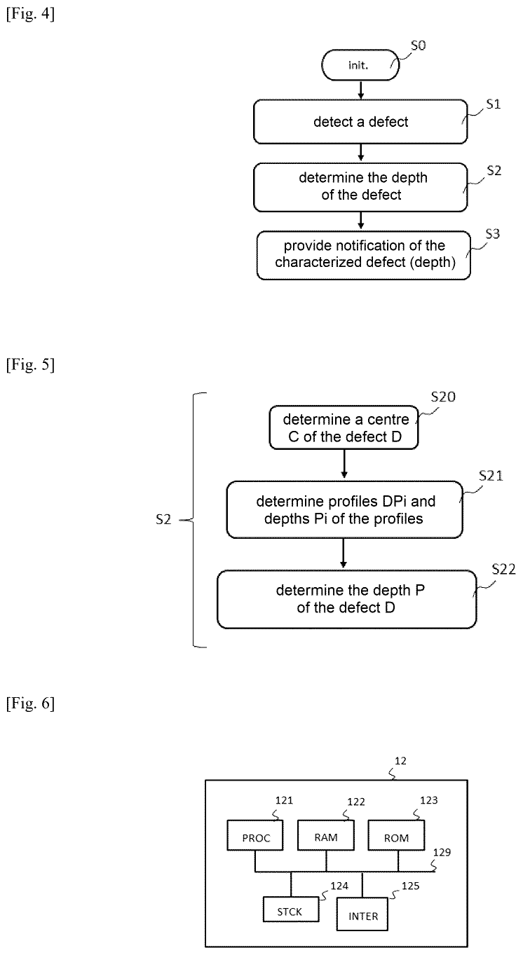

FIG. 4 illustrates steps of a method for determining the depth of a surface defect, executed by and in the processing unit 12 of the automatic inspection system 1, according to one particular and non-limiting embodiment of the invention.

Step S0 is an initial (or initializing) step at the end of which all the circuits and components of the automatic inspection system 1 are under voltage, normally supplied with power, configured and operational. In particular, the sensing device 10 is positioned on a holder or by an operator facing a region of the inspected surface AS and first pieces of information representative of the surface finish of the inspected surface AS are transmitted by the sensing device 10 to the processing unit 12. These first pieces of information form an “image matrix” of part of the analysed surface AS and are a digital instance of the surface AS, called here the surface S or image matrix S.

In a defect-detecting step S1, an operation of blurring (or smoothing) the matrix (or image) S is first applied to the image matrix instantiated by the first pieces of information obtained by the processing unit 12. According to one embodiment, the blurring operation applies blurring with a blurring radius of between 5 mm and 15 mm, and preferably with a blurring radius of 10 mm. The matrix or image resulting from this blurring contains new pieces of information representative of the surface AS, forming a blurred image matrix. Next, a triple differentiation of the blurred image matrix applied to the pieces of information resulting from the blurring is performed. The expression “triple differentiation” here designates three successive differentiation operations applied to the image matrix representative of the inspected surface AS (or of a region or segment of this surface), using three respective different differentiation operators (first a gradient, then a Hessian matrix, and lastly a specific differentiation operator).

According to one embodiment, the aforementioned triple differentiation, which comprises three successive differentiation operations, using three respective differentiation operators, may be broken down as follows:

A first differentiation (of the triple differentiation) calculates the gradient of the inspected surface, which is expressed in the form:

$$∇ s ( x , y ) = [ \frac{\frac{\partial s}{\partial x}}{\frac{\partial s}{\partial y}} ] = [ \frac{{s}_{x}}{{s}_{y}} ]$$

where S (x, y) is the image matrix after blurring obtained at the end of the blurring step S1.

A second differentiation (of the triple differentiation) calculates a Hessian matrix, which is expressed in the form:

$$H ( x , y ) = [ \begin{matrix}{S}_{xx} & {S}_{xy} \\ {S}_{yx} & {S}_{yy}\end{matrix} ] \\ where {S}_{xx} = \frac{{\partial }^{2} S ( x , y )}{\partial {x}^{2}} ; {S}_{x y} = \frac{{\partial }^{2} S ( x , y )}{\partial x \partial y} ; {S}_{y x} = \frac{{\partial }^{2} S ( x , y )}{\partial y \partial x} ; and {S}_{y y} = \frac{{\partial }^{2} S ( x , y )}{\partial {y}^{2}} ,$$

allowing local variations in planarity to be determined:

$$σ ( x , y ) = {S}_{xx}^{2} + {S}_{x y}^{2}$$

Next, a third differentiation (of the triple differentiation) finds a so-called “third derivative”, using an operator defining a rate of change of the previously determined local variations in planarity, of a nature to bring to light defects, including defects of very small size, through insertion of the resulting information into a module for detecting potential defects in a subsequent step.

The operator defining a rate of change of the previously determined local variations in planarity may be expressed by:

$$∇ σ ( x , y ) = 2 \cdot [ \begin{matrix}{S}_{xx} \cdot {S}_{xxx} + {S}_{yy} \cdot {S}_{yyx} \\ {S}_{xx} \cdot {S}_{xxy} + {S}_{yy} \cdot {S}_{yyy}\end{matrix} ]$$

Lastly, one or more potential defects D present in the inspected surface AS are detected using a defect detection module. According to one embodiment, the defect detection module is implemented by the processing unit 12. According to one embodiment, the defect detection module is a neural network (NN) of the “YOLO” type (YOLO standing for You Only Look Once). It is a question of a module implementing an algorithm known in the field of computer vision and capable of detecting predetermined objects in an image in a single scan (a single “look”) by simultaneously performing detection and classification. The YOLO algorithm is applied to the image matrix S resulting from the three successive differentiations carried out subsequent to the blurring and delivers pieces of information allowing potential surface defects present to be identified and located via the instantiation of bounding boxes each accompanied by a probability of presence of a defect in the region demarcated by the bounding box of the image matrix resulting from the three differentiations. The one or more defects D detected in the image matrix S may therefore be subjected to subsequent processing independently of one another.

Of course, the detection mode detailed above is described by way of example of embodiment and other embodiments or variants may be used to detect one or more surface defects of an object, for example via other automatic methods or even by virtue of pieces of information obtained via a user interface by an operator analysing a surface finish by means of a specific tool for viewing this surface finish.

In a step S2, the one or more defects D detected in the surface AS, by processing and analysing the image matrix S, are characterized in order to define the dimensions, and in particular the depth, of each of the defects D. For the sake of simplification of the present description, it is considered in the remainder of the description that a single defect D is detected in the image matrix S and therefore in the surface or surface segment AS. In actual fact, a plurality of defects could be detected in a surface or surface portions AS. The operations specific to the characterization of the defect D of the surface AS will now be described in the remainder of the description, with reference to FIG. 5 and FIG. 7 to FIG. 10.

Once the depth of the or each defect D has been determined accurately, it is possible to provide notification, via the system 1 or via a third-party device, of the presence of the one or more defects detected, in a step S3. According to one embodiment, such a notification is provided when the absolute value of the depth of the detected defect exceeds a predefined threshold value. It is considered here that the value of a depth may describe a defect of the depression or relief type in the inspected and analysed surface AS. Thus, a negative depth value indicates the presence of a relief. A notification of the presence or severity of a defect advantageously makes it possible to control or organize modifications in a manufacturing process and/or maintenance operations in relation to the surface or surface segment AS.

FIG. 5 illustrates details of operations carried out in the aforementioned step S2 in relation to a defect D detected in the surface AS and the depth of which must be determined with a high accuracy. Thus, step S2 is a sequence of sub-steps S20, S21 and S22 aimed successively and respectively at determining a centre of the detected defect D (step S20) then at determining a plurality of depth profiles Pi in a defect region Z containing the defect D, i.e. a region such as for example a bounding box Z instantiated by its coordinates in the image matrix S (step S21) or a more extensive region Z containing the region demarcated by a bounding box generated by a defect detection method, and then at determining a depth P called the “final” depth of the defect D, from depths Pi determined for each of the depth profiles (step S22).

More precisely, in step S20, a specific method that is already known is applied to the region Z to determine the lowest or highest point of the image matrix S in the region Z, which point is here called the “centre” of the defect in question. According to one embodiment, the region Z used extends beyond a bounding box containing a defect D to be analysed, so as to make it possible to consider the finish of the surface around the defect D in subsequent processing (for example, processing such as numerical interpolation of a surface profile affected by a defect).

According to one particular embodiment, the method used to do this is a gradient descent algorithm that allows a differentiable real function defined in a Euclidean space to be minimized. The gradient descent algorithm is then applied to the digitally instantiated surface S. It is a question of an iterative algorithm that proceeds through successive improvements. According to the algorithm, at the current point, a movement is made in a direction opposite to the gradient, so as to cause the function to decrease. The same principle is applied to search for a highest point of a defect, minimizing the opposite of the function. These operations make it possible to determine a centre C of coordinates Xc, Yc of the defect D in the image matrix S.

This example of embodiment is non-limiting and other embodiments may be used to determine the centre C of a defect. For example, an evaluation may be carried out by an operator working on an enlarged view of a defect region, which operator then designates, via a digital tool operating on the digitally instantiated surface, the centre C of a considered defect.

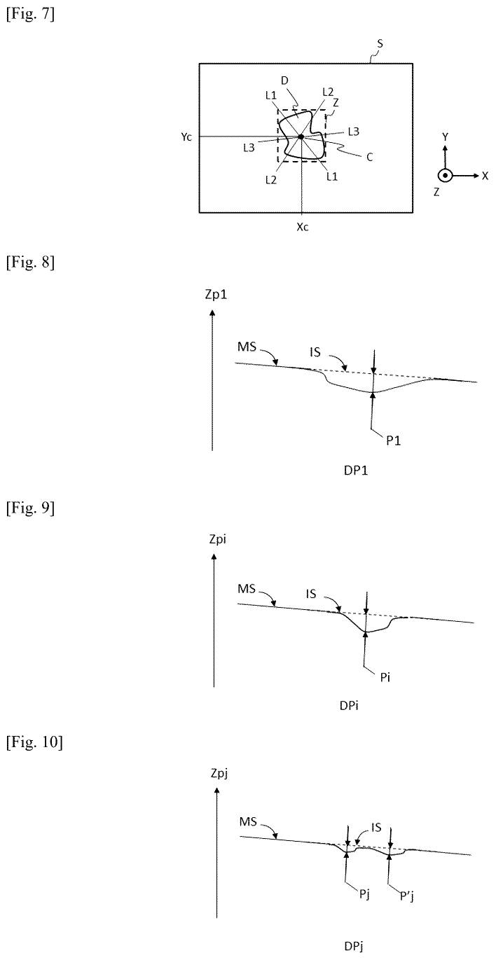

It is then possible to determine a plurality of rectilinear (straight) paths passing through the centre C of the defect D, along which paths depth profiles DPi are determined in step S21. To understand how these depth profiles DPi are determined, FIG. 7 illustrates a plurality of straight lines L1, L2 and L3 used to determine depth profiles DP1, DP2 and DP3 making it possible to determine what the local variation in the depth of the defect D is along each of the straight lines L1, L2 and L3 in the region Z surrounding the defect D. The straight lines L1, L2 and L3 pass through the centre C. Here, the number of straight lines Li, and therefore the number of depth profiles DPi, has deliberately been restricted for the purposes of simplification of the illustration. However, according to one particular embodiment, many depth profiles DPi are determined, for example several tens. According to one particular and non-limiting embodiment, sixty depth profiles are determined along sixty straight lines passing through the centre C and oriented so that each makes an angle of 3° to the straight lines adjacent to it. It is therefore possible to determine (absolute or relative) distances (or depths, or altitudes) Zp1 for each of the points on the straight line L1 in the region Z of the image matrix S. Similarly, it is possible to determine distances (or depths, or altitudes) Zp2 for each of the points on the straight line L2 in the region Z of the image matrix S and it is possible to determine distances (or depths, or altitudes) Zp3 for each of the points on the straight line L3 in the region Z of the image matrix S. These series of values here form profiles DP1, DP2 and DP3 pertaining to straight lines L1, L2 and L3, respectively. The profile DP1 is a series of depth values Zp1 along the straight line L1, the profile DP2 is a series of depth values Zp2 along the straight line L2, and so on. More generally, it is possible to determine a profile DPi forming a series of values Zpi along an ith straight line Li passing through the region Z passing through the centre C.

FIG. 8 illustrates one example of a depth profile DP1 along the straight line L1 and FIG. 9 more generally illustrates one example of a depth profile DPi along a straight line Li. Each of the profiles contains a series MS of measured values (and therefore of values of the image matrix S), which series is here called profile segment MS, as well as a series of values obtained by interpolation of these values, which series is here called interpolated profile segment IS. Thus, the interpolated profile segment of a profile is a presumption about what the determined depth profile would be in the absence of a surface defect. The maximum difference in depth between the segment MS and the segment IS, in the direction of the normal, is the depth of the profile in question.

Thus, in FIG. 7, P1 is the depth of the defect D along (or on) the profile DP1 and in FIG. 9, Pi is the depth of the defect D along (or on) the profile DPi. It will further be noted that a depth profile may exhibit a plurality of successive variations in slope (change in sign of the derivative) indicating the presence of a particular relief. In FIG. 10, one example of a depth profile DPj contains two adjacent cavities of respective depth PJ and P′j on a profile determined along a straight line Lj. Such a profile DPj may result from the singular shape of a defect or even from the presence of some component in proximity to this defect.

Returning to step S21, and with reference to FIG. 5, once the profiles DP1, DP2 and DP3 have been determined, the respective depths P1, P2 and P3 of these profiles are determined by numerical analysis so that, in step S22, a “final” value P of the depth of the defect D may be determined from all the depths of the profiles DP1, DP2 and DP3.

According to one embodiment, a weighted median is calculated to determine the “final” depth P of the defect D from the respective depths P1, P2 and P3 of the profiles DP1, DP2 and DP3.

According to one embodiment, weights may be introduced in the form of confidence indices k assigned to the various depth profiles determined. For example, when a depth profile contains variations of a nature such as to give reason to presume the presence of two very closely spaced defects, or even of an object or component (for example a rivet) in the direct vicinity of a defect, as described with reference to FIG. 10, a low weighting factor or confidence index k (for example k=0.05) is assigned to the depth profile in question (and therefore to the depth value determined in relation to this profile) so as to minimize its weight in the weighted median calculation. In the absence of such a particularity in a given profile, a nominal value is assigned to the confidence index k associated with the profile (for example k=1).

Once the depth P of the defect D has been determined, subsequent processing operations, which are optionally conditional on step S3, are carried out.

According to one embodiment, when an iterative gradient descent algorithm is used in step S20 to determine the location of the centre C of a defect D to be analysed, i.e, the lowest point or highest point of the surface of a surface defect of an object, steps S21 and S22 (of determining a plurality of depth profiles of the defect and of determining a maximum depth and a confidence index for each of the determined depth profiles, and then determining the depth of the surface defect from the determined maximum depths and confidence indices determined with reference to each of the depth profiles, respectively) are carried out for each of the iterations of the iterative gradient descent algorithm.

According to another embodiment, the centre C of a defect D to be analysed is initially determined in step S20 as being the centre of a bounding box demarcating a region containing the defect D at the end of a detection method, then sequences of steps S21 and S22 are successively reiterated so as to determine, in each new iteration, a corrected centre C based on the point determined as being the lowest or highest at the end of the previous iteration of a sequence of steps S21 and S22, until a maximum depth or relief value is obtained.

Advantageously and cleverly, using a plurality of depth profiles, traced along rectilinear paths each oriented differently in the region of a defect, makes it possible to identify and distinguish depth-profile orientations for which a single defect (hollows or bumps) appears in the profile, with respect to other depth-profile orientations for which multiple surface variations (hollows or bumps) appear in the profile. Such a distinction advantageously makes it possible to consider these two types of profiles in different ways (for example by establishing weightings) and in fine to avoid disturbances to a measurement of depth (or relief) due to components normally present in the vicinity of an analysed defect (for example, a rivet, a joint between two neighbouring surface components, etc.).

FIG. 6 schematically illustrates one example of an internal architecture of the processing unit 12 of the automatic inspection system 1, this processing unit being configured to execute the method described above.

According to the example of hardware architecture shown in FIG. 6, the processing unit 12 then comprises the following, connected by a communication bus 129: a processor or central processing unit (CPU) 121; a random-access memory (RAM) 122; a read-only memory (ROM) 123; a storage unit such as a hard disk (or a reader of a storage medium reader, such as a reader of a secure-digital (SD) card) 124; and a communication interface 125 allowing the processing unit 12 to communicate with remote devices such as a surface inspection device or even devices of manufacturing or maintenance sites.

The processor 121 of the processing unit 12 is capable of executing instructions loaded into the RAM 122 from the ROM 123, from an external memory (not shown), from a storage medium (such as an SD card), or from a communication network. When the processing unit 12 is powered on, the processor 121 is capable of reading instructions from the RAM 122 and of executing them. These instructions form a computer program that causes the processor 121 of the processing unit 12 to implement all or some of an automatic inspection method as described above.

All or some of such an automatic method for inspecting surfaces, aircraft surfaces for example, may then be implemented in software form via execution of a set of instructions by a programmable machine, for example a digital signal processor (DSP) or a microcontroller, or be implemented in hardware form by a dedicated machine or component, for example a field-programmable gate array (FPGA) or an application-specific integrated circuit (ASIC). In general, the processing unit 12 comprises electronic circuitry configured to implement an automatic method for inspecting surfaces of solid objects. Of course, the processing unit 12 further comprises all of the components that are usually present in a system comprising a control unit and its peripherals, such as a power circuit, a power management circuit, one or more clock circuits, a zeroing circuit, input/output ports, interrupt inputs and bus drivers, this list not being exhaustive.

1. A method for determining a depth of a defect in a surface of an object (100), said surface being digitally instantiated in the form of a map of distances between a measured real surface of said object and a sensor of a surface inspection system configured to obtain said digitally instantiated surface (S) through an operation of scanning said real surface, said method comprising detection of said defect in said surface, by demarcating a segment called the “defect region” of said digitally instantiated surface, said method further comprises:
(i) determining a centre of said defect,
(ii) determining a plurality of depth profiles of the defect, each of said depth profiles being respectively established after a predetermined rectilinear path passing through said centre has been traced through said defect region of the digitally instantiated surface, each of said depth profiles further being determined with reference to a path different from the path determined for the other profiles among said plurality of profiles,
(iii) determining a maximum depth and a confidence index for each of said determined depth profiles, then
(iv) determining said depth of said surface defect based on said maximum depths determined and said confidence indices determined with reference to each of said depth profiles.

2. The method according to claim 1, wherein determining said maximum depth of a depth profile comprises an operation of interpolation in said depth profile.

3. The method according to claim 1, wherein determining said depth of said surface defect based on said maximum depths each determined with reference to one profile comprises a calculation of a weighted median.

4. The method according to claim 1, further comprising a step of notifying the presence of said detected defect in said surface.

5. The method for manufacturing an aircraft component comprising a method for determining the depth of a defect according to claim 1, and a step of modifying said surface based on at least one piece of information representative of said defect.

6. A system for determining a depth of a defect in a surface of an object, said surface being digitally instantiated in the form of a map of distances between a measured real surface of said object and a sensor of a surface inspection system configured to obtain said digitally instantiated surface through an operation of scanning said real surface, said system comprising electronic circuitry configured to detect said defect in said surface, through demarcation of a segment called the “defect region” of said digitally instantiated surface, said system further comprises electronic circuitry configured to:
(i) determine a centre of said defect by applying a gradient descent algorithm to said defect region of said digitally instantiated surface,
(ii) determine a plurality of depth profiles of the defect, each of said depth profiles being respectively established after a predetermined rectilinear path passing through said centre has been traced through said defect region of the digitally instantiated surface, each of said depth profiles further being determined with reference to a path different from the path determined for the other profiles among said plurality of profiles,
(ii) determine a maximum depth and a confidence index for each of said determined depth profiles, then
(iv) determine said depth of said surface defect based on said maximum depths determined and said confidence indices determined with reference to each of said depth profiles.

7. The system according to claim 6, the system further comprising electronic circuitry configured to determine a maximum depth of a predetermined depth profile comprising an operation of interpolation in a determined depth profile.

8. The system according to claim 6, the system further comprising electronic circuitry configured to determine said depth of said surface defect based on said maximum depths each determined with reference to one profile, determining said depth of said surface defect comprising calculation of a weighted median.

9. The system according to claim 6, further comprising electronic circuitry configured to provide notification of the presence of said detected defect in said surface.

10. (canceled)

11. A non-transitory information storage device comprising a computer program product according to claim 1, when said instructions are executed by a processor of a system for determining a depth of a surface defect of a solid object.
